(19) United States
(12) Patent Application Publication
(10) Pub. No.: US 2009/0141861 A1
(43) Pub. Date: Jun. 4, 2009

(54) Penetrating Radiation Measurements

(76) Inventors: Matthew Gaved, Cambridge (GB); Michael Farquharson, London (GB)

Correspondence Address: ARENT FOX LLP, 1050 CONNECTICUT AVENUE, N.W., SUITE 400, WASHINGTON, DC, 20036, US

(21) Appl. No.: 11/597,136

(22) PCT Filed: May 23, 2005
(86) PCT No.: PCT/GB05/02002

§ 371 Date: Nov. 26, 2008

(30) Foreign Application Priority Data
May 21, 2004 (GB) 0411401.3

(51) Int. Cl. G01N 23/20

(52) U.S. Cl. 378/70

(57) ABSTRACT

The present invention describes apparatus for penetrating radiation measurements on a biological tissue sample, the apparatus comprising: a tissue sample locator; a source of penetrating radiation; a collimator to direct, in use, radiation from the source into a beam directed at the tissue sample locator; and at least two detectors for detecting radiation from the sample; the at least two detectors being configured to detect radiation from the sample at respective different angles. The present invention also describes analogous apparatus for penetrating radiation measurements on biological tissue samples.

### FIELD OF THE INVENTION

The present invention relates to apparatus and methods for making penetrating radiation (e.g. X-ray) measurements. The apparatus is particularly suited to in vitro applications. The invention has particular, although not necessarily exclusive application in the characterisation of biological tissue, for instance characterisation of tissue as normal (e.g. healthy) or abnormal (e.g. pathological). It is useful, in the diagnosis and management of cancer, including breast cancer.

### BACKGROUND

In order to manage suspected or overt breast cancer, tissue is removed from the patient in the form of a biopsy specimen and subjected to expert analysis by a histopathologist. This information leads to the disease management program for that patient. The analysis requires careful preparation of tissue samples that are then analysed by microscopy for prognostic parameters such as tumour size, type and grade. An important parameter in tissue classification is quantifying the constituent components present in the sample. Interpretation of the histology requires expertise that can only be learnt over many years based on a qualitative analysis of the tissue sample, which is a process prone to intra and inter observer variability.

Despite the relative value of histopathological analysis, there remains a degree of imprecision in predicting tumour behaviour in the individual case. Additional techniques have the potential to fine-tune tissue characterisation to a greater degree than that currently used and hence will improve the targeted management of patients.

In existing research in this field, x-ray fluorescence (XRF) techniques have been used to study trace element composition of breast tissue and have shown that breast cancer is accompanied by changes in trace elements and such measurements could contribute to tissue grading. It has also been shown that x-ray diffraction effects can operate as an effective means of distinguishing certain types of tissue. Furthermore, it has been shown that such diffraction effects could be suitably analysed to demonstrate small differences in tissue components and that this analysis could lead to a quantitative characterisation of tissues.

In co-pending PCT patent application PCT/GB04/005185 we describe an approach to characterising biological tissue samples, in which tissue characteristics are modelled using a multivariate model. The inputs to the model can include a variety of measured tissue properties, including for example, X-ray Fluorescence (XRF), energy or angular dispersive x-ray diffraction (EDXRD), Wide Angle X-ray Scatter (WAXS), Small Angle X-ray Scatter (SAXS), Ultra-Low Angle X-ray Scatter (ULAX), Compton Scatter, and linear attenuation (transmission) measurements.

A need exists for apparatus that can be conveniently used to take these multiple measurements from a tissue sample.

### SUMMARY OF THE INVENTION

It is a general aim of the present invention to provide apparatus for penetrating radiation (e.g. X-ray) measurements that enables multiple, different measurements to be taken from a biological tissue sample.

In the following, the terms “vertical”, “longitudinal” and “transverse”, and related terms are used for convenience and ease of understanding to define the orientation of elements of the apparatus relative to one another, but should not be taken to define an absolute orientation in space. “Vertical” is used to mean generally parallel to the incident beam of radiation. “Longitudinal” and “transverse” refer to axes that are perpendicular to one another and to the vertical (beam) axis.

In a first aspect the invention provides apparatus for penetrating radiation measurements on a biological tissue sample, the apparatus comprising:

a tissue sample locator;
a source of penetrating radiation;
a collimator to direct radiation from the source into a beam directed at the tissue sample locator; and
at least two detectors for detecting radiation from the sample;
the at least two detectors being configured to detect radiation from the sample at respective different angles.

In a second aspect the invention provides apparatus for penetrating radiation measurements on a biological tissue sample, the apparatus comprising:

a tissue sample locator;
a source of penetrating radiation;
a collimator to direct radiation from the source into a beam directed at the tissue sample locator; and
at least one detector for detecting radiation from the sample; the detector being adapted to be configurable in at least two configurations for detecting radiation from the sample at respective different angles.

In a third aspect the invention provides apparatus for penetrating radiation measurements on a biological tissue sample, the apparatus comprising:

a tissue sample locator;
a source of penetrating radiation;
a collimator to direct radiation from the source into a beam directed at the tissue sample locator; and
at least two detectors for detecting radiation from the sample;
the at least two detectors being adapted to detect different forms of interaction of the penetrating radiation with the sample.

The different forms of interaction might include, for example, X-ray Fluorescence (XRF), energy or angular dispersive x-ray diffraction (EDXRD), Wide Angle X-ray Scatter (WAXS), Small Angle X-ray Scatter (SAXS), Ultra-Low Angle X-ray Scatter (ULAX), Compton Scatter, and linear attenuation (transmission) measurements.

In some embodiments of the various aspects of the invention, the apparatus may also include means for scanning the beam over a sample located by the tissue sample locator. In this case, the detector(s) preferably moves with the beam.

In a preferred embodiment of the present invention the biological tissue sample comprises body tissue of human or animal origin. The body tissue samples may be obtained via surgical procedures or veterinary procedures. Alternatively, the biological tissue sample may be obtained from cell cultures or cell lines. These cell cultures or cell lines may have been grown or propagated or developed in Petri dishes or the like.

Any of a number of suitable detectors can be used, including for example CCD arrays or large area amorphous silicon or selenium detectors.

In the various aspects of the invention, and particularly in relation to embodiments of the second aspect of the invention, one or more detectors with variable geometry can be provided in order that the angle of scattered radiation that they are able to detect can be changed. This variable geometry may also be useful to adjust the detector(s) for different applications.

For example, the angle of the detector or of an associated collimator relative to the incident radiation beam can be made adjustable. Even for wide angle scatter measurements, the variation in angle is likely to be a few degrees at most, and it will generally be desirable to ensure the angle of the detector is set accurately, at least to within a few minutes of the nominal angle. The angular position of a moveable detector or collimator is preferably controlled by high precision micro-actuators. Examples of suitable actuators include piezo-electric actuators, micro-actuated worm drives, electromagnetic actuators and hydraulic actuators.

It will also often be important to be able to verify the angle of the detectors and/or associated collimators relative to the incident radiation beam. In some preferred embodiments, therefore, a reference beam or signal is provided that can be used to identify misalignment of the incident radiation beam and the detector. This may be desirable, for example, to correct for temperature effects.

Another example of a variable geometry detector is one that can be displaced substantially linearly in the incident beam transmission axis; for a given detector extent (laterally of the incident radiation beam), as the detector is moved closer to the sample from which measurements are being taken, the angle of scattered radiation that can be detected increases.

Although such variable geometry detectors provide a convenient way to obtain multiple measurements with a minimum number of detectors, they result in longer measurement acquisition periods because it is necessary to take one measurement, re-configure the detector, and then take a further measurement.

Where the speed of obtaining a result is important, therefore, it will generally be preferable to employ multiple detectors that can take measurements simultaneously. The layout of the multiple detectors is therefore preferably selected in order that they can all remain in their operational position without interfering with one another's operation.

Suitable arrangements include lateral or concentric arrays above, below or to the sides of the sample with respect to the direction of the incident radiation beam. Conveniently, detectors for measurements including Compton scatter and XRF can be located above the sample (i.e. to the side from which the incident radiation beam is directed onto the sample) as with these measurements it is practical to detect ‘back-scatter’.

In some cases it may be desirable to use more than one detector to take any specific measurement. For instance, XRF measurements typically are of a longer duration than others of the measurement types referred to above, but the duration can be reduced by employing multiple XRF detectors.

Advantageously, these measurements can be used in combination as inputs to a multivariate model to analyse and/or characterise a tissue sample, for instance as disclosed in co-pending PCT patent application numbers PCT/GB04/005185.

The invention also provides methods for operating and software for controlling apparatus and systems as set out above and described below.

### BRIEF DESCRIPTION OF THE DRAWINGS

Embodiments of the invention are described below by way of example with reference to the accompanying drawings, in which:

FIG. 1 schematically illustrates apparatus in accordance with a first embodiment of the invention;

FIG. 2 schematically illustrates apparatus in accordance with a second embodiment of the invention;

FIG. 3 schematically illustrates apparatus in accordance with a third embodiment of the invention; and

FIG. 4 is a plan view of the detector arrangement of the FIG. 3 apparatus.

### DESCRIPTION OF EMBODIMENTS

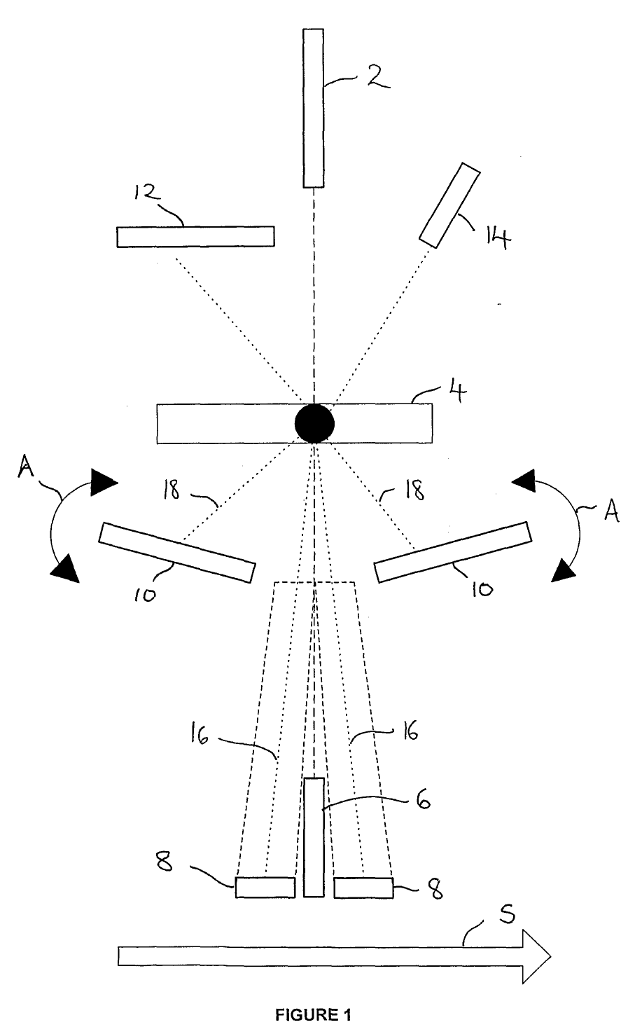

FIG. 1 illustrates and apparatus suitable for in vitro irradiation of a tissue sample (e.g. a breast tissue sample that has been obtained from a biopsy). The apparatus comprises a penetrating radiation (in this example X-ray) beam source 2 that directs a beam of X-ray radiation onto the tissue sample 4 being examined. A series of detectors 6, 8, 10, 12, 14 are arranged below and above the sample 4 to detect both transmitted and scattered X-ray radiation.

In use, the source and detector arrangement is scanned across the full length of the tissue sample, as indicated by arrow ‘S’, whilst the sample is held stationary.

The incident beam can be a slit-form beam having a width (into the page as illustrated in FIG. 1) sufficient to extend across the full width of the sample. Alternatively, the beam may be narrower (e.g. a pencil-form beam) and be scanned laterally across the sample at each step in the longitudinal direction.

Looking in more detail at the detector arrangement illustrated in FIG. 1, it can be seen that below the sample 4 there are two of pairs of detectors 8,10 arranged to detect scattered radiation 16,18 and a single detector 6 for detecting transmitted radiation 14. The detectors 8 are for detecting ultra-low angle scatter (around 1 degree). The detectors 10 are for detecting wider angle scatter (of about 5 to 8 degrees in the present example).

Above the sample, there is a detector 12 for detecting Compton scatter at high angles (about 120 degrees and more) and an XRF detector 14.

In this example, the wide-angle scatter detectors 10 are arranged to be variable angle (indicated by arrows ‘A’) so that, they can be used to detect scattered radiation at multiple selected angles. The ability to vary the angle can also be used during set up and calibration of the apparatus to make any minor adjustments to the angle of the detector needed to compensate for temperature changes for instance.

Preferably the detector angle is changed using one or more micro-actuators. For example, the detector assembly or an associated assembly as a whole can be mounted on a piezo driven/positioned rig/mount to allow its (angular) position to be adjusted relative to the rest of the equipment.

Taking the example of micro actuation for calibration in set up and e.g. ‘equipment checking’ modes, the micro-adjustment capability could be employed to change the position of the collimator assembly or detector assembly in relation to a reference beam or signal. This will enable the angle and alignment of the collimator/detector assembly (which is crucial), to be subject to verification on a regular basis (e.g. to take account of temperature effects, equipment being moved/knocked around, etc). A piezo system would enable the position to be both verified and controlled through either a continuous feedback system or (for example) every time the system (generator) is fired up or once a day or on some other regular cycle.

This micro actuation can also or alternatively be employed for setting collimator arrays or detectors at different angles to (i) the radiation source incident beam or (ii) an angle to the beam. In (i) the angle setting of the collimator beam can be considered a ‘first order’ angle to the incident beam. In (ii) the angle setting of the collimator beam can be considered ‘second order’ because it is set in relation to the ‘output’ angle being investigated (e.g. 6 degrees for wide angle, 120 degrees for Comptbn, etc).

For example, there may be clinical reasons for selecting particular angles or a number of different angles for different detectors. With piezo or other micro-actuation controls, one or both e.g. wide angle detectors 10 (or more if further detectors are provided) can be set to the same angle, or any combination of angles e.g.: all set to the same angle (e.g. 6 degrees); one (or one pair) set to at one angle (e.g. 6 degrees) and the other(s) at a second angle (e.g. 7 degrees); or, all set at difference angles (e.g. if there are four detectors, one each to 5.5 deg, 6 deg, 6.5 deg, 7 deg), etc.

Some detector angle configurations may be preferred, for example when looking for very high sensitivity (e.g. using detectors all set at the same angle), whereas other detector angle configurations might be better to maximise specificity of tissue characterisation (e.g. two, three or more angles).

Generally it will be desirable to fix the detector angles during a scan. However, there may be occasions where varying the angle of one or more detectors during a scan will be beneficial. For example, in a configuration of (say) four wide-angle detectors, all might be set at an angle (e.g. 6 degrees) in a standard mode. The angle in this standard mode may be chosen, for example, to maximise diagnostic differentiation between normal and abnormal tissue.

Where it is determined, however, that for a particular region of the tissue sample there is an increased probability that the tissue is abnormal, it may be advantageous to immediately reconfigure the angles of the collimators/detectors to, for example, maximise differentiation between abnormal benign and abnormal malignant tissue. It may be, for instance, that one of the four detectors remains at the same angle (e.g. 6 degrees) and the other three are set at three different angles (e.g. 6.8 deg., 7.0 deg. and 7.5 deg respectively).

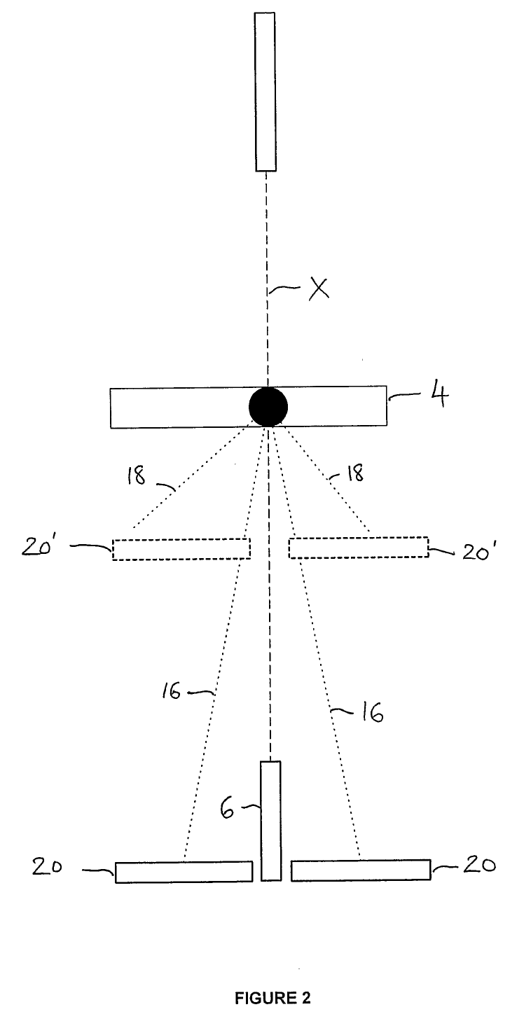

FIG. 2 illustrates an alternative detector configuration that can be used for measuring low- and wide-angle scatter of penetrating (e.g. X-ray) radiation. The Compton scatter and XRF detectors of FIG. 1 are not shown here, but could be used.

In the FIG. 2 apparatus, a single array (e.g. pair) of detectors 20 are used for both low- and wide-angle measurements. The detectors 20 of the array can be moved linearly along the axis X of the transmitted radiation beam from a position (shown in solid lines and labelled 20) further from the sample 4 to a position (shown in dashed lines and labelled 20′) closer to the sample 4.

In the position further from the sample, the detectors 20 are arranged to detect low-angle scatter 16. When the detectors 20 are moved to the position (20′) closer to the sample, they are able to detect wide-angle scatter 18.

In use, the measurements are taken at one detector position 20, the detectors are moved so the other position 20′ and a further set of measurements are taken, without the sample being moved.

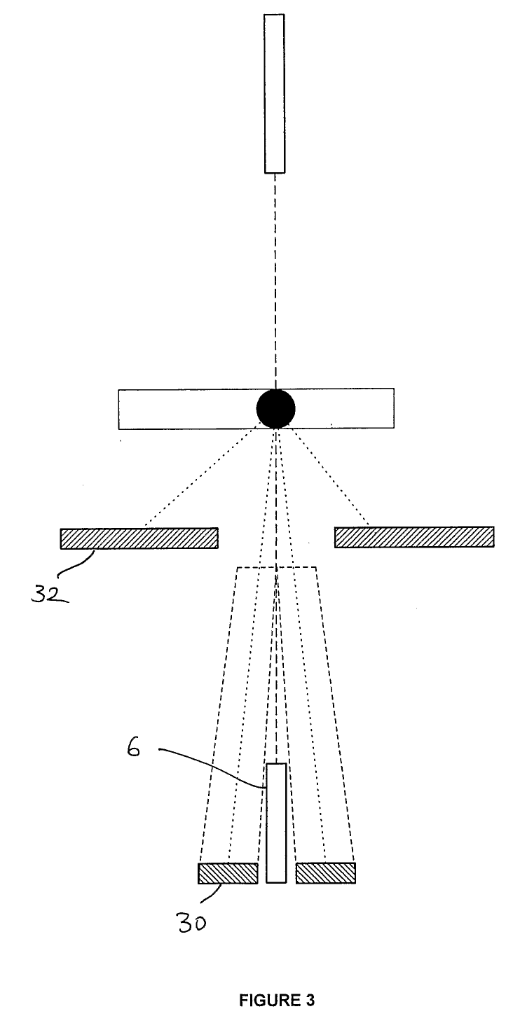

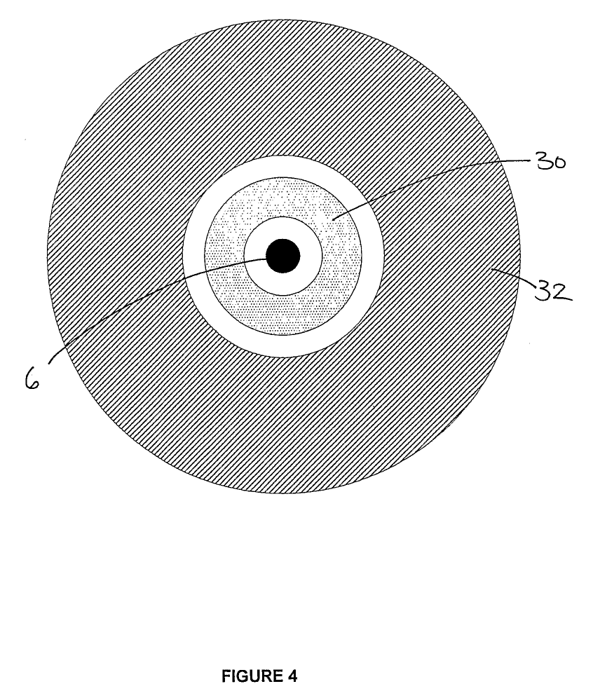

FIGS. 3 and 4 show a third detector arrangement for low- and wide-angle scatter measurements. As with the example of FIG. 1, there are separate detectors 30,32 for the low- and wide-angle measurements. In this case, however, as best seen in FIG. 4, the detectors 30, 32 are annular. The low-angle detector 30 is mounted concentrically within and below the wide-angle detector 32. A detector 6 for transmission measurements is also mounted concentrically within the low-angle detector 30.

This detector configuration provides a larger detector surface area than the arrangement of FIG. 1.

As with the FIG. 2 example, although Compton scatter and XRF detectors are not shown in FIG. 3, they can advantageously be mounted above the sample as they are seen in FIG. 1.

Measurements obtained using the detector configurations of FIGS. 1, 2 and 3 can advantageously be used in combination as inputs to a multivariate model to analyse and/or characterise a tissue sample, for instance as disclosed in co-pending PCT patent application number PCT/GB04/005185.

It will be appreciated that description above is given by way of example and various modifications, omissions or additions to that which has been specifically described can be made without departing from the invention.

11-14. (canceled)

15. Apparatus for penetrating radiation measurements on a biological tissue sample, the apparatus comprising:
a tissue sample locator;
a source of penetrating radiation;
a collimator to direct, in use, radiation from the source into a beam directed at the tissue sample locator; and
at least two detectors for detecting radiation from the sample;
the at least two detectors being adapted to detect different forms of interaction of the penetrating radiation with the sample.

16. Apparatus for penetrating radiation measurements on a biological tissue sample, the apparatus comprising:
a tissue sample locator;
a source of penetrating radiation;
a collimator to direct, in use, radiation from the source into a beam directed at the tissue sample locator;
and at least one detector for detecting radiation from the sample;
the detector being adapted to be configurable in at least two configurations for detecting radiation from the sample at respective different angles.

17. Apparatus according to claim 1, the different forms of interaction comprise: x-ray fluorescence (XRF), energy or angular dispersive x-ray diffraction (EDXRD), Wide Angle X-ray Scatter (WAXS), Small Angle X-ray Scatter (SAXS), Ultra-Low Angle X-ray Scatter (ULAX), Compton Scatter, and linear attenuation (transmission) measurements.

18. Apparatus according to claim 1, wherein the apparatus comprises means for scanning the beam, in use, over a sample located by the tissue sample locator.

19. Apparatus according to claim 1, wherein at least one of the at least two detectors is configured to move with the beam.

20. Apparatus according to claim 1, wherein one or more detectors with variable geometry are provided.

21. Apparatus according to claim 1, wherein the angle of the detector or of an associated collimator relative to the incident radiation beam is adjustable.

22. Apparatus according to claim 7, wherein the angular position of a moveable detector or collimator is controlled by high precision micro-actuators.

23. Apparatus according to claim 1, wherein a reference beam or signal is provided that is used to identify misalignment of the incident radiation beam and the detector.

24. Apparatus according to claim 1, wherein the detector or detectors are provided in a lateral or concentric arrays.

25. Apparatus according to claim 1, wherein the detector or detectors are provided above, below or to the sides of the sample with respect to the direction of the incident radiation beam.

26. Apparatus according to claim 1, wherein detector (s) for measurements of Compton scatter and XRF are located above the sample.

27. Apparatus according to claim 1, wherein more than one detector is configured to take a specific measurement.

28. Apparatus according to claim 2, wherein one or more detectors with variable geometry are provided.

29. Apparatus according to claim 2, wherein the angle of the detector or of an associated collimator relative to the incident radiation beam is adjustable.

30. Apparatus according to claim 2, wherein a reference beam or signal is provided that is used to identify misalignment of the incident radiation beam and the detector.

31. Apparatus according to claim 2, wherein the detector or detectors are provided in a lateral or concentric arrays.

32. Apparatus according to claim 2, wherein the detector or detectors are provided above, below or to the sides of the sample with respect to the direction of the incident radiation beam.

33. Apparatus according to claim 2, wherein detector (s) for measurements of Compton scatter and XRF are located above the sample.

34. Apparatus according to claim 2, wherein more than one detector is configured to take a specific measurement.
